(19) United States
(12) Patent Application Publication
(10) Pub. No.: US 2006/0235156 A1
(43) Pub. Date: Oct. 19, 2006

(54) Silylated thermoplastic vulcanizate compositions

(76) Inventors: Roy Melvin Griswold, Ballston Spa, NY (US); Timothy J. Fahrenkopf, Rensselaer, NY (US); Francis J. McKeon, Queensbury, NY (US)

Correspondence Address: GE ADVANCED MATERIALS - SILICONES, 771 OLD SAW MILL RIVER ROAD, TARRYTOWN, NY, 10591-6701, US

(21) Appl. No.: 11/105,971

(22) Filed: Apr. 14, 2005

(51) Int. Cl. C08F 8/00

(52) U.S. Cl. 525/192

(57) ABSTRACT

A process for making a thermoplastic vulcanizate includes blending a thermoplastic first polymer, an elastomeric second polymer, a carboxylic anhydride, a free radical generator, and a tackifier to provide a tacky first blend containing the thermoplastic first polymer and grafted elastomeric second polymer with the tackifier dispersed therein; then, reacting the first blend with a silane to provide a non-tacky thermoplastic vulcanizate product.

### BACKGROUND OF THE INVENTION

There are sealant/adhesive applications for which silane crosslinked hot melts exhibiting improved adhesion, tensile strength and thermal resistance are desirable properties for industrial assembly and construction. Typifying such applications are sealant/adhesives for automotive window glazing and industrial assembly of insulated glass units. Additional sealant/adhesive requirements include adequate green strength and economical cure time for ease of handling during assembly, along with maintaining adhesion during thermal cycles. The sealant/adhesives desired properties include a tensile strength of 200 psi or greater, 100% modulus of 100 psi or greater, elongation of 200% or greater, and Shore A Hardness of 30 or greater. A sealant/adhesive that can be used as a single seal offers lower cost due to use of automated application.

Two types of adhesives and sealants exist in the industry for insulated glass manufacture. These include thermoset and thermoplastic compositions. Chemically cured thermoset compositions include polysulfides, polyurethanes, and silicones. Thermoplastic compositions include hot melt butyl rubber based compositions. The desirability for hot melt butyl compositions is due to the low moisture vapor transmittance (MVT) property. However, these are susceptible to poor adhesion and creep resistance due to low and high temperature fluctuations leading to deformation of the assembled construction.

U.S. Pat. No. 6,448,343 to Schombourg, J. F., et. al., which is incorporated by reference herein, discloses silane vulcanized thermoplastic elastomers with a gel content of 10 to 50 wt % and elongation of 400%. Compositions claimed consist of a dispersed phase reaction product of a polymer or copolymer, free radical generator, carboxylic acid anhydride, and an aminosilane, and a continuous phase of a second polymer. However, the process disclosed in this patent fails to provide for the stoichiometric amount of water required to fully crosslink the dispersed phase via silyloxy hydrolysis and condensation. The specification teaches that no additional source of water is required. Additionally, no mention is made incorporating plasticizer(s), resin tackifier(s), silane, condensation catalyst(s), and or polymeric additives.

U.S. Patent Publication No. 20030032728 to Arhart, R. J., et. al. discloses moisture curable, melt processible graft ethylene copolymers. The silyl-grafted ethylene is prepared by copolymerization of epoxy glycidyl methacrylate into the polymer backbone, providing a graft site for the aminosilane. Improved adhesion would be anticipated. However, crosslinking through the silyloxy groups is not disclosed as part of the process. A post cure step increasing cure time to achieve ultimate properties is required. The necessity for preparation of a copolymerization material increases the cost and limits the flexibility for variation in the degree of silyloxy crosslinking. No mention is made of moisture releasing additives, condensation catalyst, or tackifiers.

U.S. Patent Publication No. 20020151647 to Laughner, M. K., et. al. discloses thermoplastic polymer blend compositions that include a thermoplastic matrix resin phase which is substantially free of crosslinking, and a dispersed, silane-grafted elastomer phase. These compositions are prepared by a multi-step process that begins with melt mixing a thermoplastic resin and an elastomer that have similar viscosities at temperatures used for melt mixing. A catalyst that promotes silane crosslinking, branching or both is preferably, but not necessarily, added to the melt mixed phases either while they are in a melt state or after they have been recovered in a solid state. The melt mixed phases and the optional catalyst is then subjected to moisture, either before or after the melt mixed phases are converted to a shaped article, to effect branching and crosslinking within domains of the dispersed elastomer phase. The crosslinking and branching build elastomer molecular weight and stabilize dispersed domain shapes. The elastomer phase may contain a non-elastomeric polymer. A second, non-grafted elastomer phase may also be included in the thermoplastic polymer blend compositions. Such a multi-step process requires special storage and handling to prevent pre-crosslinking, a post moisture cure which increases cost and complexity.

Baratuci, J. L., et. al., in U.S. Pat. Nos. 5,851,609 and 6,355,328 describe a unitary spacer/sealant used in multipane window compositions wherein the core material and adhesive are isobutylene based polymer(s), plasticizer, fillers, adhesion promoters and amorphous polyalphaolefin polymers. Also disclosed are thermoplastic or thermoplastic elastomers made by dynamic vulcanization. No mention is made of crosslinking through silyloxy groups, additives releasing moisture for hydrolysis or condensation of the silyloxy groups, nor are condensation catalysts disclosed for the core material or adhesive compositions.

There is yet a need for a hot melt composition having an extended range for the dispersed phase of hot melt sealant/adhesive compositions and improved creep resistance.

### BRIEF DESCRIPTION OF THE INVENTION

A process for making a thermoplastic vulcanizate includes blending a thermoplastic first polymer, an elastomeric second polymer, a carboxylic anhydride, a free radical generator, and a tackifier to provide a tacky first blend containing the thermoplastic first polymer and grafted elastomeric second polymer with the tackifier dispersed therein; then, reacting the first blend with a silane to provide a non-tacky thermoplastic vulcanizate product.

The present invention advantageously incorporates resin tackifiers and also preferably additives releasing moisture. Incorporation of tackifier resins extends the range for the dispersed phase and therein further improves creep resistance. Incorporation of additives releasing moisture at prescribed temperatures facilitates complete alkoxy hydrolysis and condensation, thereby increasing the crosslinked phase, a feature which improves the creep resistance as determined by decreased melt flow.

### DETAILED DESCRIPTION OF THE INVENTION

The present invention is directed to silylated thermoplastic vulcanizate (TPVSi) compositions based upon a dispersed phase of carboxylic acid anhydride modified or peroxide grafted elastomer, further reacted with silanes, preferably aminosilanes, a continuous phase thermoplastic, organic resin tackifiers, additives that release moisture to facilitate alkoxysilyl hydrolysis and condensation crosslinking of the dispersed phase, and a condensation catalyst. These compositions exhibit an extended range of mechanical properties over the prior art as well as improved creep resistance as determined by decreased melt flow. The thermoplastic vulcanizate compositions disclosed have the excellent MVT properties of butyl rubber based sealant/adhesives suited for insulated glass manufacture. Further, the disclosed TPVSI compositions compared to compositions that cure during insulated glass manufacture have reduced volatile materials reducing chemical fogging.

In an embodiment of the invention, the TPVSi compositions are a blend of: (a) a crystalline or partly crystalline thermoplastic first polymer, (b) a an elastomeric second polymer (rubber phase); (c) a carboxylic acid anhydride, incorporated as a comonomer in or grafted with a free radical generator such as peroxide or other suitable means onto elastomeric second polymer; (d) a silane, preferably an aminosilane; and an organic resin tackifier. In an embodiment the composition also includes a moisture source.

In accordance with one embodiment of the invention, based upon total composition weight, the composition includes from about 5 wt % to about 40 wt % of the thermoplastic first polymer, from about 60 wt % to about 95 wt % of the elastomeric second polymer, from about 0.01 wt % to about 1.0 wt % of the carboxylic anhydride, from about 0.005 wt % to about 0.5 wt % of peroxide, from about 0.25 wt % to about 2.5 wt % of the silane, and from about 5 wt % to about 25 wt % of the tackifier.

In accordance with another embodiment of the invention, based upon total composition weight, the composition includes from about 10 wt % to about 30 wt % of the thermoplastic first polymer, from about 70 wt % to about 90 wt % of the elastomeric second polymer, from about 0.05 wt % to about 0.5 wt % of the carboxylic anhydride, from about 0.025 to about 0.25 wt % of peroxide, from about 0.5 wt % to about 2.0 wt % of the silane, and from about 10 wt % to about 25 wt % of the tackifier.

In accordance with yet another embodiment of the invention, based upon total composition weight, the composition includes from about 15 wt % to about 25 wt % of the thermoplastic first polymer, from about 75 wt % to about 85 wt % of the elastomeric second polymer, from about 0.1 wt % to about 0.4 wt % of the carboxylic anhydride, from about 0.05 to about 0.2 wt % of peroxide, from about 1.0 wt % to about 2.0 wt % of the silane, and from about 15 wt % to about 20 wt % of the tackifier.

In another embodiment the composition also includes from about 1 wt % to about 60 wt %, more preferably from about 10 wt % to about 50 wt %, and most preferably from about 15 wt % to about 20 wt % (based upon total composition weight) of a moisture source.

In accordance with a preferred embodiment the process of the present invention, in contrast to prior methods of making TPV, is performed in a single operation. Grafting, crosslinking and coupling are performed continuously in the blending apparatus. The process is also suitable for use in a batch compounding system, such as a Banbury or Krupp mixer, if desired.

Suitable thermoplastic polymers (a) include, but are not limited to, polypropylene (PP); polyethylene, especially high density (PE); polystyrene (PS); acrylonitrile butadiene styrene (ABS); styrene acrylonitrile (SAN); polymethylmethacrylate (PMMA); thermoplastic polyesters (PET, PBT); polycarbonate (PC); polyamide (PA); polyphenylene ether (PPE) or polyphenylene oxide (PPO).

Such polymers may be made by any process known in the art, including, but not limited to, by bulk phase, slurry phase, gas phase, solvent phase, interfacial, polymerization (radical, ionic, metal initiated (e.g., metallocene, Ziegler-Natta)), polycondensation, polyaddition or combinations of these methodologies.

Suitable polyolefin rubber phase components (b) include, but are not limited to, any polymer which can be reacted such as to yield an carboxylic anhydride containing polymer like, e.g., ethylene propylene copolymer (EPR); ethylene propylene diene terpolymer (EPDM), butyl rubber (BR); natural rubber (NR); chlorinated polyethylenes (CPE); silicone rubber; isoprene rubber (IR); butadiene rubber (BR); styrene-butadiene rubber (SBR); styrene-ethylene butylene-styrene block copolymer (SEBS), ethylene-vinyl acetate (EVA); ethylene butylacrylate (EBA), ethylene methacrylate (EMA), ethylene ethylacrylate (EEA), ethylene-alpha-olefin copolymers (e.g., EXACT and ENGAGE, LLDPE (linear low density polyethylene)), high density polyethylene (HPE) and nitrile rubber (NBR). Polypropylene is not suitable as this phase since it has a tendency to degrade during crosslinking; however, if the polypropylene is a copolymer or graftomer of polypropylene with an acid anhydride, then it may be used. Preferably, the polymer is an ethylene polymer or copolymer with at least 50% ethylene content (by monomer), more preferably at least 70% of the monomers are ethylene.

It is possible to have the polymers for the two phases be the same wherein the acid anhydride is pre-added with peroxide or other method of grafting to one part of the polymer, which pre-reacted polymer will act as the rubber phase within the TPV. Such pre-addition includes the possibilities of having the acid anhydride present as a comonomer in the polymer or pre-reacting the acid anhydride with the polymer. In either of these two cases, the addition of the separate acid anhydride would not be necessary since it is present in the polymer. This process can be accomplished in a single continuous mixer, several mixers in tandem, a batch mixer or any other suitable mixer typically used for the processing of elastomers and thermoplastic polymers.

A third alternative is that the polymer of the rubber phase and the thermoplastic phase may the same polymer, but the acid anhydride is added to the polymer as a whole. In such a case when the silane is added part of the polymer would form the rubber phase, while another part would not react (given the relatively small amount of anhydride and silane present). It is important that a proper degree of phase separation between the rubber and thermoplastic phases is created during the process. This process can be accomplished in a single continuous mixer, several mixers in tandem, a batch mixer or any other suitable mixer typically used for the processing of elastomers and thermoplastic polymers.

In the case of two different polymers, the polymer that is more reactive with the acid anhydride will be grafted by the acid anhydride and will act as the rubber phase in the TPV. However, the process is flexible and, if desired, can be modified by the selective addition of the additives to the process.

The polymer which is to become the rubber phase must be extrudable and should be capable of grafting with the acid anhydride or be modified by the acid anhydride during its manufacture.

The melting point of the thermoplastic phase should be less than the decomposition temperature of the aminosilane, as well as the decomposition temperature of the acid anhydride (unless the acid anhydride is a comonomer in the polymer).

The polymers may have unimodal, bimodal or multimodal molecular weight distributions. The melt flow of the polymers may be any of those known in the art for use in forming thermoplastics and rubbers.

Any carboxylic acid anhydrides which can be grafted or reacted onto or into the polymer to be the rubber phase by any possible mechanism may be used. It is preferable, that there be an unsaturation either in the polymer, or more preferably, in the acid anhydride, to accomplish this grafting. The unsaturation of the carboxylic acid anhydride may be internal or external to a ring structure, if present, so long as it allows for reaction with the polymer. The acid anhydride may include halides. Mixtures of different carboxylic acid anhydrides may be used. Exemplary unsaturated carboxylic acid anhydrides suitable for use in the present invention include, but are not limited to, isobutenylsuccinic, (±)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxylic, 3,4,5,6-tetrahydrophthalic, bromomaleic, and dichloromaleic anhydrides.

These acid anhydrides can be present as a comonomer in the polymer of the rubber phase or can be grafted onto the polymer which will be the rubber phase.

The amount of acid anhydride to use is about 0.01 to about 1.0 wt % based on the total amount of polymer present. The free radical generator (preferably peroxide) is usually present in about half the percentage by weight of the carboxylic acid anhydride, although other percentages can be used when appropriate.

The use of both silane crosslinking agent and tackifier in the formulation of the invention provides a product having a three dimensional polymer structure which is advantageously used for adhesion and sealing, for example as a glazing compound for glass. The blend is initially tacky until cured by, for example, reaction with the silane, upon which it loses its tackiness until the TPV compound is reheated, for example, when employed as a hot melt adhesive. The hot melt compound regains its tackiness when melted for application to a surface to be bonded (e.g., glass) and then becomes non-tacky when cooled. Without the silane curing, the compound remains permanently tacky, which makes it unsuitable for use in many applications such as, e.g., window glazing compounds.

The silanes for use herein are preferably aminosilanes having at least one hydrolyzable group, e.g., alkoxy, acetoxy or halo, preferably alkoxy. Preferably, there are at least two such hydrolyzable groups capable of undergoing crosslinking condensation reaction so that the resulting compound is capable of undergoing such crosslinking. A mixture of different aminosilanes may be used.

The amine must have a sufficient rate of reaction with the acid anhydride. Generally, tertiary amines do not react appropriately with the acid anhydride and should be avoided. The amino group may be bridged to the silicon atom by a branched group to reduce yellowing of the resulting composition.

The silane may be represented by the formula YNHBSi(OR)ₐ (X)₃₋ₐ, wherein a=1 to 3, preferably 3, Y is hydrogen, an alkyl, alkenyl, hydroxy alkyl, alkaryl, alkylsilyl, alkylamine, C(═O)OR or C(═O)NR, R is an acyl, alkyl, aryl or alkaryl, X may be R or halo. B is a divalent bridging group, which preferably is alkylene, which may be branched (e.g. neohexylene) or cyclic. B may contain heteroatom bridges, e.g., an ether bond. Preferably B is propylene. Preferably, R is methyl or ethyl. Methoxy containing silanes may ensure a better crosslinking performance than ethoxy groups. Preferably, Y is an amino alkyl, hydrogen, or alkyl. More preferably, Y is hydrogen or a primary amino alkyl (e.g., aminoethyl). Preferably, X is Cl or methyl, more preferably methyl. Examplary silanes are gamma-amino propyl trimethoxy silane (SILQUEST® A-1110 from GE); gamma-amino propyl triethoxy silane (SILQUEST® A-1100); gamma-amino propyl methyl diethoxy silane; 4-amino-3,3-dimethyl butyl triethoxy silane, 4-amino-3,3-dimethyl butyl methylediethoxysilane, N-beta-(aminoethyl)-gamma-aminopropyltrimethoxysilane (SILQUEST® A-1120), H₂NCH₂CH₂NHCH₂CH₂NH(CH₂)₃Si(OCH₃)₃ (SILQUEST® A-1130) and N-beta-aminoethyl)-gamma-aminopropylmethyldimethoxysilane (SILQUEST® A-2120). Other suitable amino silanes are as follows: 3-(N-allylamino)propyltrimethoxysilane, 4-aminobutyltriethoxysilane, 4-aminobutyltrimethoxysilane, (aminoethylaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl] ethylenediamine, N-methylaminopropyltrimethoxysilane, bis-(gamma-triethoxysilylpropyl)amine (SILQUEST® A-1170), and N-phenyl-gamma-aminopropyltrimethoxysilane (SILQUEST® Y-9669).

If the amino silane is a latent aminosilane, i.e., a ureidosilane or a carbamatosilane, then the blending temperature must be sufficient so that the respective blocking group comes off from the amine and allows the amine to react with the acid anhydride functionality, about 150 to 230EC. Examples of such latent aminosilanes are tert-butyl-N-(3-trimethoxysilylpropyl)carbamate, ureidopropyltriethoxysilane, and ureidopropyltrimethoxysilane. Other carbamato silanes which may be used are disclosed in U.S. Pat. No. 5,220,047, which is incorporated herein by reference. Preferably, so as to avoid the additional complexity of deblocking, the aminosilane is not such a latent aminosilane.

The amino silane should be present at 250 to 25,000 ppm based on weight of both polymers. It should also be present at a molar equivalency ratio to the acid anhydride of about 0.1 to 10, more preferably 0.9 to 1.1, most preferably, about a 1:1 ratio.

The silane may be carried on a carrier such as a porous polymer, silica, titanium dioxide or carbon black so that it is easy to add to the polymer during the mixing process. The silane can also be blended with a compatible processing oil or wax. This is especially useful in formulations that already contain oil and/or will benefit from the use of an oil as a processing aid, plasticizer, lower oil absorption formulation and/or softening agent. Exemplary materials are ACCUREL polyolefin (Akzo Nobel), STAMYPOR polyolefin (DSM) and VALTEC polyolefin (Montell), SPHERILENE polyolefin (Montell), AEROSIL silica (Degussa), MICRO-CEL E (Manville) and ENSACO 350G carbon black (MMM Carbon). White oils, i.e., paraffinic oils, paraffinic waxes are useful carriers for the silane, but any oil compatible with the silane and the composite formulation can be used.

Suitable commercially available tackifying agents include, e.g., partially hydrogenated cycloaliphatic petroleum hydrocarbon resins available under the EASTOTAC series of trade designations including, e.g., EASTOTAC H-100, H-115, H-130 and H-142 from Eastman Chemical Co. (Kingsport, Tenn.) available in grades E, R, L and W, which have differing levels of hydrogenation from least hydrogenated (E) to most hydrogenated (W), the ESCOREZ series of trade designations including, e.g., ESCOREZ 5300 and ESCOREZ 5400 from Exxon Chemical Co. (Houston, Tex.), and the HERCOLITE 2100 trade designation from Hercules (Wilmington, Del.); partially hydrogenated aromatic modified petroleum hydrocarbon resins available under the ESCOREZ 5600 trade designation from Exxon Chemical Co.; aliphatic-aromatic petroleum hydrocarbon resins available under the WINGTACK EXTRA trade designation from Goodyear Chemical Co. (Akron, Ohio); styrenated terpene resins made from d-limonene available under the ZONATAC 105 LITE trade designation from Arizona Chemical Co. (Panama City, Fla.); aromatic hydrogenated hydrocarbon resins available under the REGALREZ 1094 trade designation from Hercules; and alphamethyl styrene resins available under the trade designations KRISTALEX 3070, 3085 and 3100, which have softening points of 70EC, 85EC and 100EC, respectively, from Hercules.

Sources of moisture suitable for use in the present invention include water, and preferably compounds which water bound in the molecular structure, but which release the water at the temperature at which the blending process is conducted. Such compounds containing bound water include, for example, hydrates of inorganic compounds such as hydrated inorganic oxides, hydroxides and salts. Particular examples include aluminum trihydrate, Al(OH)₃, Mg(OH)₂, Ca(OH)₂, and the like.

A free radical generator would be required if the carboxylic acid anhydride is being grafted by a free radical mechanism onto the polymer, but it is not required if the acid anhydride is either grafted via another mechanism or being a comonomer of the polymer. Suitable free-radical catalysts can be selected from the group of water soluble or oil soluble peroxides, such as hydrogen peroxide, ammonium persulfate, potassium persulfate, various organic peroxy catalysts, such as dialkyl peroxides, e.g., diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane, 2,5-dimethyl-2,5-di(t-butylperoxy)hexane, 2,5-dimethyl-2,5-di(t-butylperoxy)hexyne-3, dicumyl peroxide, alkyl hydrogen peroxides such as t-butyl hydrogen peroxide, t-amyl hydrogen peroxide, cumyl hydrogen peroxide, diacyl peroxides, for instance acetyl peroxide, lauroyl peroxide, benzoyl peroxide, peroxy ester such as ethyl peroxybenzoate, and the azo compounds such as 2-azobis(isobutyronitrile).

The free radical generator may be present at 1/100 to 1/1 based on the molar quantity of the acid anhydride.

Standard additives such as stabilizers (UV, light or aging), antioxidants, metal deactivators, processing aids, waxes, fillers (silica, TiO₂, CaCO₃, carbon black, silica, etc.), and colorants may be added to the TPVSi. Additionally, blowing agents may be added to the polymers so that when they are extruded the polymer will form a foam. Examples of such blowing agents are volatile hydrocarbons, hydrofluorocarbons, and chlorofluorocarbons. Commonly know foaming agent like azocarbonamide or sodium bicarbonate decompose at elevated temperature to yield gaseous products. These are all chemical foaming processes. Foams can also be produced by injection of liquid or gaseous foaming agent into the polymer melt. Examples are, e.g., butane, CO₂, nitrogen, water, helium, etc. The amount of such a blowing agent should be at 0.1 to 50 weight percent of the polymers.

In a first reaction the carboxylic acid anhydride is grafted (most preferably by a free radical mechanism) onto the rubber phase polymer. This reaction may be done with both polymers present or with the two polymers separated, though it is preferred to accomplish this with both polymers present. As stated before, alternatively, this step may be effectively accomplished by the inclusion of the carboxylic acid anhydride as a comonomer in the rubber phase polymer (in which case, no free radical generator is necessary). The polymer should be grafted/copolymerized with carboxylic acid anhydride prior to the reaction with aminosilane, since the reaction product between acid anhydride and amino silane has only a poor grafting efficiency. A prior reaction between aminosilane and acid anhydride would result in the formation of a semiamide, which could have inferior grafting properties. In this case, no crosslinking would occur. In contrast, partial degradation of the polymer and/or the plasticizing effect of the semiamide may lead to a rise in melt flow index (MFI).

It is preferable to add free radical generator with the anhydride during the grafting step to induce the grafting of the acid anhydride onto the rubber phase polymer.

If the thermoplastic polymer is not present during the grafting, then it should be blended in with the grafted rubber phase polymer prior to the addition of the aminosilane; however, such method suffers deficiency in terms of the mechanical properties of the resulting TPVSi.

The second step is the addition of the amino silane to the rubber phase grafted polymer/thermoplastic polymer blend. Unlike the process disclosed in U.S. Pat. No. 6,448,343 a moisture source is preferably added.

After the aminosilane is grafted onto the one polymer, it should be allowed to crosslink, so as to form the gel phase of the crosslinked polymer. No separate moisture cure needs to take place. A condensation catalyst may be used to expedite the crosslinking process, though the semi-amide should be a sufficient catalyst. One to ten minutes at an elevated temperature of from about 60EC to about 200EC should ensure such crosslinking occurs.

The total amount of additives is only about 0.4% of the total composition, about five times less than the amount needed for peroxide or vinyl silane cure. This benefits in two ways: a reduction in total cost and a reduction of fugitive peroxides, which can present safety issues.

The process of the invention can advantageously be performed as a continuous process and operated in a single step. Alternatively, the process can be a batch process. Any mixer suitable for the purpose described herein can be used. A preferred mixer is a screw type mixer with at least two feed points, one located at an upstream position along the barrel of the mixer and a second feed point located at a downstream position along the barrel. The mixer can be an extruder (single screw, twin screw, etc.), a BUSS KO-KNEADER mixer or a simple internal type mixer. The conditions for mixing depend on the polymers and degree of crosslinking.

The resulting product is a thermoplastic vulcanizate with excellent mechanical properties. The crosslinked materials have a significant gel content and a much lower MFI than the starting polymers, which should improve the creep resistance, provide higher tensile strength at break and provide materials that are harder than non-crosslinked polymer-blends. The end product has elastic properties (i.e., elongation at break of greater than 400%), but can be melt processed with methods normally known in the art for thermoplastics. The preferred gel content of the final product (i.e., rubber content) is from about 10 wt % to about 50 wt %, most preferably from about 25 wt % to about 35 wt %. The tensile and flexible moduli in the machine and transverse directions are improved, as is the dart impact strength of the material.

The TPVSi compositions are paintable and have better oil resistance. They may be used in, e.g., adhesives and sealants, cable insulations, pipes, profiles, moulded parts, foamed parts, sheets etc.

The aminosilane rubber phase modified polymer will tend to be more compatible with the thermoplastic polymer, providing for a stronger TPVSi.

### EXAMPLES

Examples and comparative examples are presented below. The examples (numbered) illustrate the invention. The comparative examples (lettered), which do not employ silane, are presented for comparison purposes only and do not illustrate the invention.

The following components are employed in the examples: isobutylene —isoprene copolymers (butyl rubber) available from ExxonMobil under the designation Butyl 268 and Butyl 165, hydrocarbon tackifier resin available from ExxonMobil Chemical under the designation Escorez 1304, high molecular weight polyisobutylene available under the designations Vistanex L-100 and L-140, maleic anhydride modified styrene ethylene-butylene styrene block copolymer available from Kraton polymers under the designations Kraton FG 1901 and Kraton FG 1924X, liquid synthetic depolymerized butyl rubber available from Hardman Co. under the designation Kalene 800, terpene-phenolic tackifier available from Arizona chemical Co. unde the designation Sylvarez TR1085, ethylene-vinyl acetate resin available from DuPont under the designation Elvax® 460, partially hydrogenated cycloaliphatic petroleum hydrocarbon resin tackifier available from Eastman Chemical Co. under the designation Eastotac H-100W, and calcium carbonate available from Pfizer under the designations Ultra-pflex and Hi-pflex.

### Examples 1-4 and A-H

The compositions for comparative examples A through D in Table 1 were prepared using a Braybender at 160° C., 150 rpm without acid anhydride grafting with subsequent reaction of an aminosilane. These exhibit higher melt flow rates with 100% modulus less than 100 psi typical of hot melt butyl rubber based sealant/adhesive compositions that exhibit increased creep. The elongation and tear results further indicate a soft pliable sealant/adhesive that does not have desirable mechanical properties for insulated glass assembly applications.

The compositions for comparative examples E, F, G and H are comparison formulations to those of Examples 1, 2, 3 and 4 (respectively), wherein maleic anhydride grafted SEBS rubber (copoly(styrene-ethylene/butylene-styrene) is the dispersed phase in a continuous butyl rubber phase. These formulations demonstrate improved creep resistance when silane aminosilane crosslinker is incorporated as observed by the decreased melt flow along with improved mechanical properties suitable for insulated glass sealant/adhesive applications.

For example, the tear strength and 100% modulus were higher for each of the examples 1-4 than for the corresponding comparative examples E-H, and the melt flow was lower.

TABLE 1

| | Formulations (%) | | | | | | | | | | | |
|---|---|---|---|---|---|---|---|---|---|---|---|---|
| | Examples | | | | | | | | | | | |
| Ingredients | A* | B* | C* | D* | E* | 1 | F* | 2 | G* | 3 | H* | 4 |
| Butyl 268 | 9.05 | | 9.05 | | 9.05 | 9.01 | | | 9.05 | 9.01 | | |
| Butyl 165 | | 9.05 | | 9.05 | | | 9.05 | 9.01 | | | 9.05 | 9.01 |
| Vistanex L-100 | 12.07 | 12.07 | | | | | | | | | | |
| Vistanex L-140 | | | 12.07 | 12.07 | | | | | | | | |
| Kraton FG* | | | | | | | | | | | | |
| Kraton FG1901 | | | | | 12.07 | 12.02 | 12.07 | 12.02 | | | | |
| Kraton FG 1924X | | | | | | | | | 12.07 | 12.02 | 12.07 | 12.02 |
| Kalene 800 | 12.07 | 12.07 | 12.07 | 12.07 | 12.07 | 12.02 | 12.07 | 12.02 | 12.07 | 12.02 | 12.07 | 12.02 |
| Escorez 1304 | 30.17 | 30.17 | 30.17 | 30.17 | 30.17 | 30.04 | 30.17 | 30.04 | 30.17 | 30.04 | 30.17 | 30.04 |
| Sylvarez TR1085 | 15.09 | 15.09 | 15.09 | 15.09 | | | | | | | | |
| Eastotac H-100W | | | | | 15.09 | 15.02 | 15.09 | 15.02 | 15.09 | 15.02 | 15.09 | 15.02 |
| Elvax 460 | 8.62 | 8.62 | 8.62 | 8.62 | 8.62 | 8.58 | 8.62 | 8.58 | 8.62 | 8.58 | 8.62 | 8.58 |
| Talc | 4.31 | 4.31 | 4.31 | 4.31 | 4.31 | 4.29 | 4.31 | 4.29 | 4.31 | 4.29 | 4.31 | 4.29 |
| Ultra-pflex | 4.31 | 4.31 | 4.31 | 4.31 | 4.31 | 4.29 | 4.31 | 4.29 | 4.31 | 4.29 | 4.31 | 4.29 |
| Hi-pflex | 4.31 | 4.31 | 4.31 | 4.31 | 4.31 | 4.29 | 4.31 | 4.29 | 4.31 | 4.29 | 4.31 | 4.29 |
| A-1100 | | | | | | 0.43 | | 0.43 | | 0.43 | | 0.43 |
| Melt Flow¹, g/10 min. | 23.4 | 14.3 | 27.8 | 12.2 | 10.6 | 8.7 | 13.9 | 11.3 | 9.8 | 6.9 | 14.6 | 11.2 |
| Tensile², psi | 152 | 148 | 265 | 204 | 353 | 273 | 288 | 286 | 460 | 335 | 349 | 339 |
| 100% Modulus², psi | 19 | 58 | 83 | 63 | 145 | 172 | 132 | 188 | 132 | 147 | 99 | 145 |
| Elongation², % | 1250 | 1137 | 1057 | 1243 | 556 | 443 | 449 | 479 | 449 | 809 | 857 | 843 |
| Tear B³, lbs/in | 49 | 27 | 62 | 76 | 101 | 101 | 80 | 95 | 80 | 93 | 81 | 92 |

¹Melt Flow per ASTM 1238 measured using a Tinius Olsen Extrusion Plastometer Model MP993a, 140° C., 2.16 Kg weight.
²ASTM D412-86
³ASTM D624-80
*Comparative Example

### Examples 5 and 6

Formulations for Examples 5 and 6 were prepared as in Examples 1-4 above. The aminosilane crosslinked dispersed phase was increased in examples 5 and 6 and the moisture introduced resulted in further decrease in melt flow indicative of increased creep resistance. Selection of tackifier resin modified the mechanical properties without altering melt flow or tear resistance.

TABLE 2

Formulations (%)
Examples

| Ingredients | 5 | 6 |
|---|---|---|
| Butyl 268 | 6.29 | 6.29 |
| Kraton FG 1924X | 14.68 | 14.68 |
| Kalene 800 | 11.98 | 11.98 |
| Escorez 1304 | 29.96 | 14.98 |
| Sylvarez TR1085 | | 14.98 |
| Eastotac H-100W | 14.98 | 14.98 |
| Elvax 460 | 8.59 | 8.59 |
| Talc | 4.29 | 4.29 |
| Water | 0.20 | 0.20 |
| Ultra-pflex | 4.30 | 4.30 |
| Hi-pflex | 4.30 | 4.30 |
| A-1100 | 0.43 | 0.43 |
| Melt Flow¹ g/10 min. | 5 | 5.1 |
| Tensile², psi | 392 | 300 |
| 100% Modulus², psi | 175 | 122 |
| Elongation², % | 496 | 622 |
| Tear B³, lbs/in | 97 | 91 |
| Shore A⁴ | 48 | 33 |

⁴ASTM D2240-86

### Examples I and 7-9

Formulations for Examples I (Comparative) and 7-9 were prepared were prepared using a Haake Rheometer at 160° C., 150 rpm then milled on a EEMCO two roll mill without heating using a 0.25 inch gap setting. Example 8 was prepared as the other examples below then further mixed in the Haake Rheometer at 200° C. to release moisture. Examples I and 7 compare a composition without silane to one with silane and moisture. Incorporation of a silane with moisture increased tear resistance and shore A hardness indicating crosslinking of the dispersed phase. Example 8 replaces water as the moisture source with an additive that releases moisture (˜30 wt %) at 200° C. resulting in similar in results to Example 7. Example 9 demonstrates the benefit of incorporating a condensation catalyst. In Example 14, 20 ppm as dibutyltin dilaurate was mixed with the aminosilane. As can be observed the addition of moisture releasing agent and a condensation catalyst yields a significant improvement in the mechanical properties indicative of further crosslinking of the dispersed phase.

TABLE 3

Formulations (%)
Examples

| Ingredients | I | 7 | 8 | 9 |
|---|---|---|---|---|
| Butyl 268 | 15.0 | 14.9 | 14.9 | 14.9 |
| Kraton FG 1924X | 18.7 | 18.6 | 18.6 | 18.6 |
| Kalene 800 | 11.2 | 11.2 | 11.2 | 11.2 |
| Escorez 1304 | 11.2 | 11.2 | 11.2 | 11.1 |
| Sylvarez TR1085 | 11.2 | 11.2 | 11.2 | 11.1 |
| Eastotac H-100W | 11.2 | 11.2 | 11.2 | 11.1 |
| Elvax 460 | 8.5 | 8.5 | 8.5 | 8.5 |
| Talc | 4.3* | 4.2 | | |
| Water | | 0.8 | | |
| Aluminum trihydrate | | | 4.2 | 4.3 |
| Ultra-pflex | 4.3* | 4.2 | 4.2 | 4.3 |
| Hi-pflex | 4.3* | 4.2 | 4.2 | 4.3 |
| A-1100 | | 0.65 | 0.65 | 0.65^{†} |
| Tensile², psi | 103 | 127 | 120 | 230 |
| 100% Modulus², psi | 65 | 66 | 61 | 64 |
| Elongation², % | 358 | 435 | 406 | 756 |
| Tear B³, lbs/in | 44 | 52 | 47 | 77 |
| Shore A⁴ | 18 | 21 | 21 | 18 |

*Dried 150EC, 2 hrs.
^{†}20 ppm dibutyl tin laurate added to the aminosilane

As can be seen from the above, the product of Examples 7-9 had a higher tear strength and tensile strength than the product of Example I. Moreover the Shore Hardness was at least as good as Examples 7 and 8, and better than the Shore Hardness of Example I.

### Examples J and 10-13

Examples 10 to 13 were prepared as per Examples 7 to 9 and are further compositional variations to attain mechanical properties suitable for IG glass hot melt glazing/adhesive applications.

TABLE 3

| | Formulations (%) | | | | |
|---|---|---|---|---|---|
| Ingredients | 10 | J* | 11 | 12 | 13 |
| Butyl 268 | 23.8 | 8.5 | 5.9 | 5.9 | 5.2 |
| Kraton FG 1924X | 29.7 | 42.7 | 29.7 | 29.7 | 25.9 |
| Kalene 800 | 5.9 | 25.6 | 5.9 | 5.9 | 15.5 |
| Escorez 1304 | | | | 17.8 | 15.5 |
| Sylvarez TR1085 | | | 17.8 | 17.8 | |
| Eastotac H-100W | 17.8 | | 17.8 | | 15.5 |
| Elvax 460 | 8.3 | 8.4 | 8.3 | 8.3 | 8.3 |
| Talc | 4.3 | 4.3 | 4.3 | 4.3 | 4.2 |
| Water | 0.5 | 0.5 | 0.5 | 0.5 | 0.5 |
| Ultra-pflex | 4.3 | 4.3 | 4.3 | 4.3 | 4.2 |
| Hipflex | 4.3 | 4.3 | 4.3 | 4.3 | 4.2 |
| A-1100 | 1.05 | 1.5 | 1.05 | 1.05 | 0.91 |
| Tensile², psi | 152 | 241 | 325 | 467 | 204 |
| 100% | 103 | 133 | 120 | 134 | 104 |
| Modulus², psi | | | | | |
| Elongation², % | 261 | 265 | 452 | 468 | 406 |
| Tear B³, lbs/in | 58 | 59 | 33 | 36 | 26 |
| Shore A | 33 | 38 | 91 | 124 | 70 |

*Comparative Example

As can be seen from the above, Comparative Example J contained no tackifier and required about 50% more silane to achieve comparable results.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A process for making a thermoplastic vulcanizate comprising:
a) blending a thermoplastic first polymer, an elastomeric second polymer, a carboxylic anhydride, a free radical generator, and a tackifier to provide a tacky first blend containing the thermoplastic first polymer and grafted elastomeric second polymer with the tackifier dispersed therein; then,
b) reacting the first blend with a silane to provide a non-tacky thermoplastic vulcanizate product.

2. The process of claim 1 wherein the thermoplastic first polymer is comprises one or more polymer selected from the group consisting of homopolymers and copolymers of polypropylene, polyethylene, polystyrene, acrylonitrile butadiene styrene, styrene acrylonitrile, polymethylmethacrylate, thermoplastic polyesters, polycarbonate, polyamide, polyphenylene ether, polyphenylene oxide and combinations thereof.

3. The process of claim 1 wherein the elastomeric second polymer comprises one or more polymers selected from the group consisting of ethylene propylene copolymer, ethylene propylene diene terpolymer, butyl rubber, natural rubber, chlorinated polyethylene, silicone rubber, isoprene rubber, butadiene rubber, styrene-butadiene rubber, SEBS, ethylene-vinyl acetate, ethylene butylacrylate, ethylene methacrylate, ethylene ethylacrylate, ethylene-alpha-olefin copolymers, high density polyethylene and nitrile rubber.

4. The process of claim 1 wherein the carboxylic anhydride is selected from the group consisting of isobutenylsuccinic, (±)-2-octen-1-ylsuccinic, itaconic, 2-dodecen-1-ylsuccinic, cis-1,2,3,6-tetrahydrophthalic, cis-5-norbornene-endo-2,3-dicarboxylic, endo-bicyclo[2.2.2]oct-5-ene-2,3-dicarboxylic, methyl-5-norbornene-2,3-carboxylic, exo-3,6-epoxy-1,2,3,6-tetrahydrophthalic, maleic, citraconic, 2,3 dimethylmaleic, 1-cyclopentene-1,2-dicarboxyl ic, 3,4,5,6-tetrahydrophthalic, bromomaleic and dichloromaleic anhydrides.

5. The process of claim 1 wherein the silane has the formula
YNHBSi(OR)ₐ(X)₃₋ₐ,
wherein a=1 to 3, Y is hydrogen, an alkyl, alkenyl, hydroxy alkyl, alkaryl, alkylsilyl, alkylamine, C(═O)OR or C(═O)NR, R is an acyl, alkyl, aryl or alkaryl, X is R or a halogen wherein R is methyl or ethyl, B is a divalent straight chain, branched chain or cyclic hydrocarbon bridging group, or B may contain heteroatom bridges.

6. The process of claim 5 wherein R is methyl, Y is an amino alkyl, hydrogen, or alkyl, and X is Cl or methyl.

7. The process of claim 1 wherein the silane is selected from the group consisting of gamma-amino propyl trimethoxy silane, gamma-amino propyl triethoxy silane, gamma-amino propyl methyl diethoxy silane, 4-amino-3,3-dimethyl butyl triethoxy silane, 4-amino-3,3-dimethyl butyl methylediethoxysilane, N-beta-(aminoethyl)-gamma-aminopropyltrimethoxysilane, H₂NCH₂CH₂NHCH₂CH₂NH(CH₂)₃Si(OCH₃)₃, N-beta-(aminoethyl)-gamma-aminopropylmethyldimethoxysilane, 3-(N-allylamino) propyltrimethoxysilane, 4-aminobutyltriethoxysilane, 4-aminobutyltrimethoxysilane, (aminoethylaminomethyl)-phenethyltrimethoxysilane, aminophenyltrimethoxysilane, 3-(1-aminopropoxy)-3,3,dimethlyl-1-propenyltrimethoxysilane, bis[(3-trimethoxysilyl)-propyl]ethylenediamine, N-methylaminopropyltrimethoxysilane, bis-(gamma-triethoxysilylpropyl)amine, -phenyl-gamma-aminopropyltrimethoxysilane, tert-butyl-N-(3-trimethoxysilylpropyl)carbamate, ureidopropyltriethoxysilane and ureidopropyltrimethoxysilane.

8. The process of claim 1 wherein the silane is carried on a porous particulate carrier or is preprocessed with a polymer.

9. The process of claim 8 wherein the porous particulate carrier is selected from silica, titanium dioxide, carbon black and polyolefins.

10. The process of claim 1 wherein the tackifier comprises one or more tackifier resin selected from the group consisting of partially or fully hydrogenated cycloaliphatic petroleum hydrocarbon resins, partially or fully hydrogenated aromatic modified petroleum hydrocarbon resins; aliphatic-aromatic petroleum hydrocarbon resins; styrenated terpene resins made from d-limonene and alpha-methylstyrene resins.

11. The process of claim 1 further including blending a moisture source with the first polymer, second polymer, carboxylic anhydride, free radical generator and tackifier in step (a).

12. The process of claim 11 wherein the moisture source is water.

13. The process of claim 11 wherein the moisture source comprises an inorganic hydrated compound.

14. The process of claim 13 wherein the inorganic hydrated compound is selected from the group consisting of AI(OH)₃, Mg(OH)₂ and Ca(OH)₂.

15. The process of claim 1 wherein the blending is conducted as a continuous process.

16. The process of claim 1 further comprising also blending one or more components selected from the group consisting of UV stabilizers, antioxidants, metal deactivators, processing aids, waxes, fillers, colorants and blowing agents.

17. The process of claim 1 wherein the free radical generator comprises a compound selected from the group consisting of hydrogen peroxide, ammonium persulfate, potassium persulfate, various organic peroxy catalysts, such as dialkyl peroxides, e.g., diisopropyl peroxide, dilauryl peroxide, di-t-butyl peroxide, di(2-t-butylperoxyisopropyl)benzene, 3,3,5-trimethyl 1,1-di(tert-butyl peroxy)cylohexane, 2,5-dimethyl-2,5-di(t-butylperoxy)hexane, 2,5-dimethyl-2,5-di(t-butylperoxy)hexyne-3, dicumyl peroxide, t-butyl hydrogen peroxide, t-amyl hydrogen peroxide, cumyl hydrogen peroxide, acetyl peroxide, lauroyl peroxide, benzoyl peroxide, ethyl peroxybenzoate and 2-azobis(isobutyronitrile).

18. The process of claim 1 wherein the blending is performed in a screw type mixer-extruder.

19. A thermoplastic vulcanizate produced in accordance with the method of claim 1.

20. A hot melt adhesive produced in accordance with the method of claim 1.
